(19) United States
(12) Patent Application Publication
(10) Pub. No.: US 2026/0098789 A1
(43) Pub. Date: Apr. 9, 2026

(54) PLUME CAPTURE AND BIOSIGNATURE DETECTION INSTRUMENT

(71) Applicant: Honeybee Robotics, LLC, Longmont, CO (US)

(72) Inventors: Frank Sheeran, Pasadena, CA (US); Isabel King, Los Angeles, CA (US); Manuel Gonzalez Parra, Altadena, CA (US); Kathryn Bywaters, Monrovia, CA (US)

(21) Appl. No.: 19/349,285

(22) Filed: Oct. 3, 2025

Related U.S. Application Data
(60) Provisional application No. 63/703,318, filed on Oct. 4, 2024.

(51) Int. Cl. G01N 1/08; G01N 1/10; G01N 1/44; G01N 21/3563

(52) U.S. Cl. CPC G01N 1/08; G01N 1/10; G01N 1/44; G01N 21/3563; G01N 2001/1006; G01N 2001/1031; G01N 2001/1062; G01N 2021/3572; G01N 2201/025

(57) ABSTRACT

A system and method for capturing ice particles in a vacuum is provided. The system includes a clamshell apparatus. The clamshell includes a stand and a base positioned on top of the stand. A pair of linear actuators is operatively connected to the stand and a lid. The lid is operatively connected to the based movable between an open and closed position. The lid includes a grid with a plurality of apertures. An ultralight gel is positioned within the plurality of apertures and a soft metal sheet positioned behind the grid and the ultralight gel.

### CROSS-REFERENCE TO RELATED APPLICATIONS

This application claims priority to U.S. Provisional Application No. 63/703,318, filed on Oct. 4, 2024, the entire contents of which are hereby incorporated by reference.

### FEDERAL GOVERNMENT RIGHTS STATEMENT

This invention was made with government support under SBIR Contract 80NSSC23CA132 awarded by the National Aeronautic Space Administration (NASA). The government has certain rights in the invention.

### BACKGROUND OF THE DISCLOSURE

The subject matter disclosed herein relates to a system for capturing samples, and in particular to a system for capturing sample material while flying or traversing through a gaseous or icy phase plume.

The Cassini spacecraft discovered plumes emanating from the south pole of Enceladus that appear to be sourced from a subsurface liquid water ocean chemically interacting with a rocky core below. The plume contains mostly H2O vapor and ice grains. Gas and grains in (or traced to) the plume also contain sub-percent amounts of gases at thermodynamic disequilibrium, such as CO2, CH4, and H2; organic matter and bioessential elements such as C, N, and P, and silica that suggests fast transport through the subsurface ocean from a hydrothermal seafloor source.

To analyze the composition of the plumes, a sample capture system configured to be housed in a spacecraft is desired having the features described herein.

### BRIEF DESCRIPTION OF THE DISCLOSURE

According to one aspect of the disclosure a system for capturing ice particles in a vacuum. The system includes a clamshell apparatus. The clamshell includes a stand and a base positioned on top of the stand. A pair of linear actuators is operatively connected to the stand and a lid. The lid is operatively connected to the based movable between an open and closed position. The lid includes a grid with a plurality of apertures. An ultralight gel is positioned within the plurality of apertures, and a soft metal sheet positioned behind the grid and the ultralight gel.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1A is an illustration of a Plume particle acquisition system flight design and configuration on a notional flight mission in accordance with an embodiment;

FIG. 1B is an illustration of a Plume particle acquisition system in accordance with an embodiment;

FIG. 2 is a chart illustrating Plume particle acquisition system measurements of the isotopic ratio of plume methane carbon relative to that of plume CO2 carbon baseline, and that of methane hydrogen relative to that of plume H2O baseline in accordance with an embodiment;

FIG. 3 is a chart illustrating Plume particle acquisition system measurements of the methane/ethane ratio in the plume to distinguish biological and abiotic inputs to plume CH4 in accordance with an embodiment;

FIG. 4A is a diagram illustrating that Plume particle acquisition system can locate Enceladus on an isotopic map of oxygen, thereby allowing testing of longstanding hypotheses on the origins of outer solar system material in accordance with an embodiment;

FIG. 4B is a diagram illustrating that Plume particle acquisition system can locate Enceladus on an isotopic map of carbon-hydrogen, thereby allowing testing of longstanding hypotheses on the origins of outer solar system material in accordance with an embodiment.

FIG. 5 are schematic illustrations of a Plume particle acquisition system small volume cell that enables a compact, sensitive laser spectroscopy system with low sample requirements; one image is of a TLS multipass gas cell, part of the Sample Analysis at Mars (SAM) on Curiosity; the second image is a diagram of CAS, with coiled hollow fiber that has a moderate path length (L=5 m) and a sample volume of ˜1 mL in accordance with an embodiment;

FIG. 6 is a block diagram illustrating the Plume particle acquisition system volatile metering concept; sample collector volume is heated and pressurized with Valve 1 open; this valve is then closed, and Valve 2 is opened to deliver an aliquot of the total gaseous sample to the CAS for analysis; the metering volume can be used in a similar manner to deliver calibrant for analysis in accordance with an embodiment;

FIG. 7 includes illustrations of an aerogel capture surface before testing; nine silica aerogel monoliths were mounted to a PLA backing using Stycast; a capture surface integrated with Plume particle acquisition system breadboard clamshell is show; cables hold a K-type thermocouple measuring the aerogel temperature in accordance with an embodiment;

FIG. 8 illustrate CAD Model of open and closed clamshell mechanism; a silicone patch heater is placed on the back of the clamshell is visible in the closed position in accordance with an embodiment;

FIG. 9 illustrates silica aerogel monolith mounted inside vacuum chamber atop a 5 W patch heater; an IR camera in vacuum chamber focused on top aerogel surface during test in accordance with an embodiment;

FIG. 10 illustrates methane pressurized water being aerosol sprayed into a bath of LN2; a methanated ice sieved to the desired particle size is also shown in accordance with an embodiment;

FIG. 11 illustrates an end-to-end ice shooting testbed in accordance with an embodiment;

FIG. 12 illustrates a Plume particle acquisition system breadboard integrated in vacuum chamber testbed; control test capture surface with a single aerogel monolith and indium is also shown, in accordance with an embodiment;

FIG. 13 illustrates representative images of testing (test 4); still frame of ice impacting the aerogel grid in vacuum; an aerogel grid once removed from the chamber after testing is also shown, in accordance with an embodiment;

FIG. 14 are graph representations of measurements from the CAS for methanated ice tests; of note, the highest concentration of methane is achieved during “slug #2”, in accordance with an embodiment; and

FIG. 15 is an illustration of another sample containment system developed for the NASA Comet Astrobiology Exploration Sample Return (CAESAR) mission.

The detailed description explains embodiments of the disclosure, together with advantages and features, by way of example with reference to the drawings.

### DETAILED DESCRIPTION OF THE DISCLOSURE

The Cassini spacecraft discovered plumes emanating from the south pole of Enceladus that appear to be sourced from a subsurface liquid water ocean chemically interacting with a rocky core below, and able to sustain life. The plume contains mostly H2O vapor and ice grains. Gas and grains in (or traced to) the plume also contain sub-percent amounts of gases at thermodynamic disequilibrium, such as CO2, CH4, and H2; organic matter and bioessential elements such as C, N, and P, and silica that suggests fast transport through the subsurface ocean from a hydrothermal seafloor source.

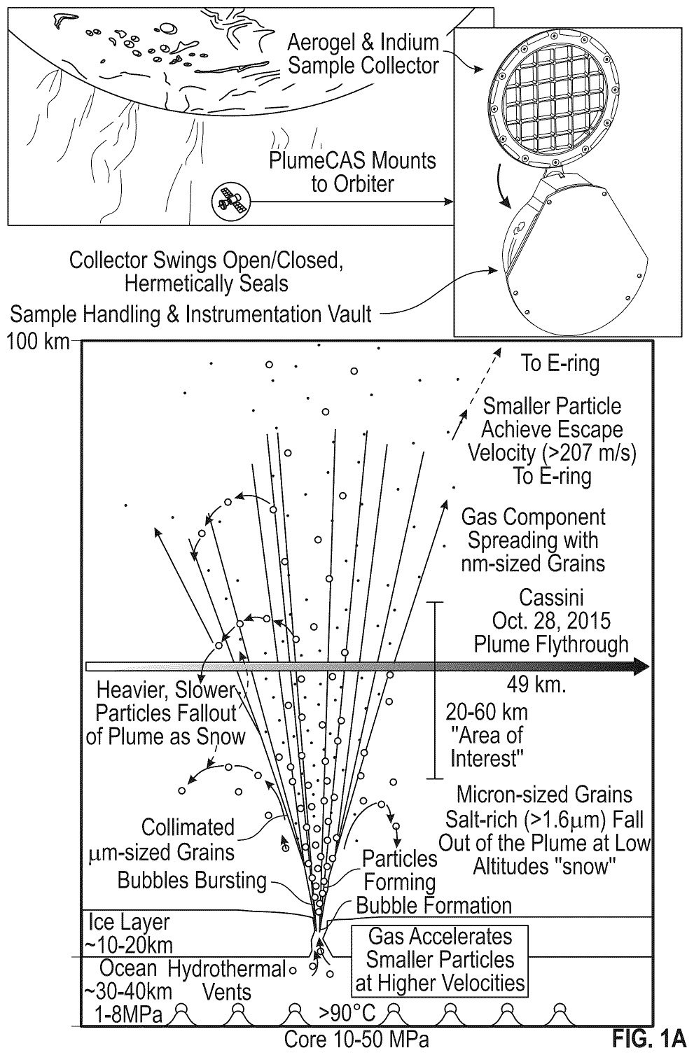

End-member hypotheses of a chemically active but lifeless ocean, and a detectable subsurface biosphere, could be tested by mission concepts prioritized by the planetary science and astrobiology community for initiation in this decade. The Plume particle acquisition system provides a sample capture, accumulation, handling, and isotope analysis approach could play a critical role in such missions. This system has the potential to be low size, weight, and power (SWaP) and flexible, as it may be used in either Enceladus flyby (high speed) or orbiter (low speed) mission scenarios. These factors make it applicable to many mission concepts including Discovery, New Frontiers, and Flagship mission classes. The flight concept of operations entails Plume particle acquisition system opening a ram-facing collector during plume fly-throughs to accumulate sample in an indium-backed aerogel matrix (FIG. 1A). This then seals and heats to deliver aliquots of volatilized sample to the capillary absorption spectrometer (CAS) for analysis.

One of the challenges of capturing the sample in an application such as to the moon Enceladus is the speed of the spacecraft while flying through the plume. The flyby conditions in this application may include ice particles that are 10 nm to 10 microns in diameter where the ice particles are 90% water ice, 5% dry ice, and 5% other materials. The particles may have a vertical speed on the order of 100 m/s while the orbiter speed is 150-200 m/s with a flyby speed of 2000-4000 m/s.

Referring to FIG. 1B, a system (e.g., Plume particle acquisition system) 100 is provided. System 100 may be configured to capture particles, such as icy or frozen particles, in a vacuum environment. The system 100 may include a capture assembly 102. Capture assembly may include a first or base portion 104 rotationally coupled to a second or catch portion 106. For instance, second portion 106 may rotate with respect to first portion 104 by a hinge 108. Thus, second portion 106 may rotate between an open position and a closed position. As described in more detail herein, the second portion 106 includes a capture member 110. In some instances, capture material 110 includes a gelatin material, such as an aerogel. The capture member 110 is configured to extend outside of the spacecraft during operation and into the path of the particles emitted in the plume. As discussed in more detail herein, the first portion 104 is configured to receive the second portion 106 and extract gaseous fluids from the ice captured in the capture member 110. The first portion 104 may be fluidly coupled to a CAS system 112. As discussed in more detail herein, the CAS system 112 is configured to determine the compounds and molecules present in the gaseous fluids.

As mentioned, second portion 106 may include capture member 110. For instance, capture member 110 may be positioned at a first side 1061 of second portion 106. First side 1061 may selectively face first portion 104 when capture assembly 102 (e.g., second portion 106) is in the closed position. Additionally or alternatively, first side 1061 may selectively be directed toward a plume or flow of particles when capture assembly 102 is in the open position. Capture member 110 may thus capture, trap, catch, or otherwise secure particles from the plume and lock or seal the captured particles within capture assembly 102.

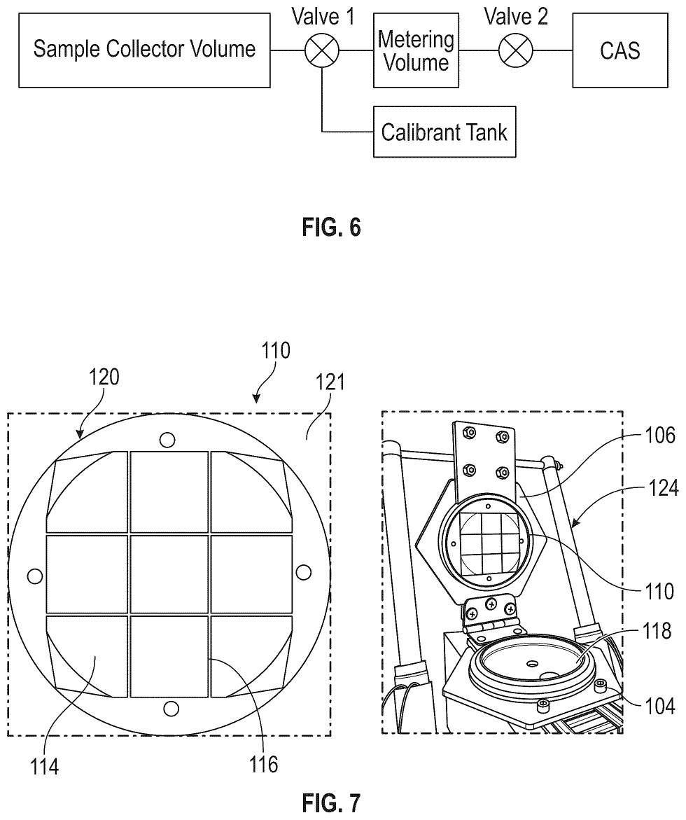

Capture member 110 may include an insert member 120. Referring briefly to FIG. 7, insert member 120 may be attached or coupled at first side 1061 of second portion 106. Insert member 120 may be configured to selectively support gelatin material (e.g., aerogel) 114. Insert member 120 may be formed from a metal, such as aluminum, Indium, or the like. However, it should be understood that insert member 120 may be or include any suitable material. Insert member 120 may be formed as a grid pattern. For instance, insert member 120 may include a plurality of cross-tines 116. The plurality of cross-tines 116 may intersect each other at predominantly right angles. Thus, insert member 120 may form a plurality of pockets. Gelatin material 114 may thus be received within each of the plurality of pockets.

In some instances, a back plate 121 is provided at second portion 106. For instance, back plate 121 may be in planar contact with second portion 106 (e.g., at first side 1061). Back plate 121 may be positioned relative to insert member 120. Accordingly, back plate 121 may be positioned between insert member 120 and first side 1061 of second portion 106. Back plate 121 may be formed from or include a soft metal sheet. Thus, back plate 121 may be positioned behind gelatin material 114.

Capture assembly 102 may include an extraction system 118. Extraction system 118 may be positioned at first portion or base portion 104. Extraction system 118 may be selectively coupled with capture member 110 (e.g., when capture assembly 102 is in the closed position). Extraction system 118 may be configured to extract or otherwise remove collected particles (e.g., icy particles) from capture member 110 (e.g., from gelatin material 114). For instance, the collected particles may be sublimated at extraction system 118 such that gases are collected at extraction system 118.

System 100 may include capillary absorption spectrometer (CAS) 112. CAS 112 may be operably or fluidly coupled with extraction system 118. Thus, as mentioned, CAS 112 may selectively receive material (e.g., fluids, particles, gases, etc.) from extraction system 118. In detail, when capture assembly 102 (e.g., second or catch portion 106) is in the closed position, material may be delivered to CAS 112 (e.g., via a conduit, tube, pipe, hose, or the like).

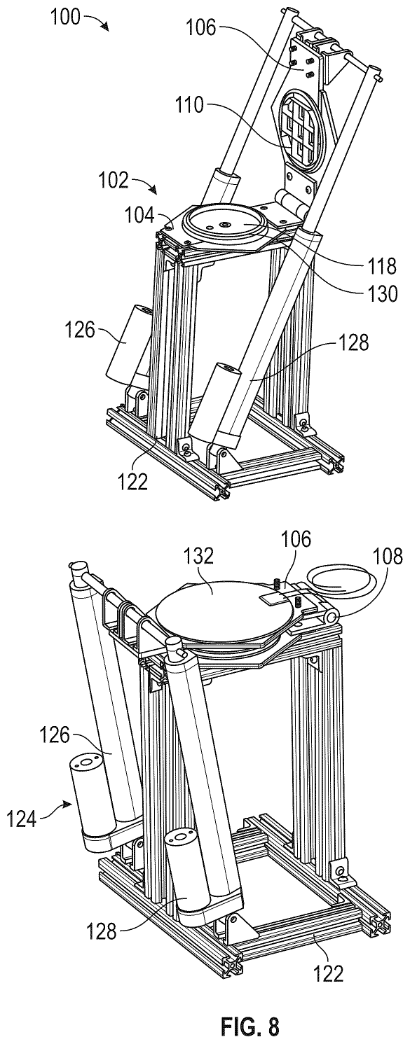

Referring briefly to FIG. 8, system 100 may include a stand or stand member 122. In at least some instances, stand 122 is coupled to a vehicle (e.g., a flythrough vehicle, a drone, a spacecraft, an orbiter, or the like). Capture assembly 102 may be attached at or to stand 122 (e.g., opposite the vehicle). For instance, first or base portion 104 may be coupled, fixed, or otherwise connected to stand 122. As would be expected, second portion 106 may then rotate away from stand 122 when moving to the open position.

System 100 (e.g., capture assembly 102) may include an actuator assembly 124. Actuator assembly 124 may be operably coupled with capture assembly 102. For instance, actuator assembly 124 may be coupled to second portion 106. Actuator assembly 124 may selectively move second portion 106 between the closed position and the open position. In some instances, actuator assembly 124 is positioned at hinge 108. However, actuator assembly 124 may be or include any suitable style or number of actuators.

According to at least one embodiments, actuator assembly 124 includes a first actuator arm 126 and a second actuator arm 128. First actuator arm 126 may be coupled at a first side of capture assembly 102. For instance, first actuator arm 126 may be coupled to each of stand 122 and second or catch portion 106 at a first lateral side thereof. Similarly, second actuator arm 128 may be coupled at a second side of capture assembly 102. For instance, second actuator arm 128 may be coupled to each of stand 122 and second or catch portion 106 at a second lateral side thereof. For one example, each of first actuator arm 126 and second actuator 128 is a linear actuator. Additionally or alternatively, each of first actuator arm 126 and second actuator arm 128 may be attached to a bracket member extending from second portion 106.

When second portion 106 is in the closed position (e.g., facing first portion 104), second portion 106 may be sealed with respect to first portion 104. For instance, capture member 110 may be sealed with respect to extraction system 118. Accordingly, capture assembly 102 may include a sealing member 130 (FIG. 8). Sealing member 130 may be positioned between first pr base portion 104 and second or catch portion 106. Sealing member 130 may be configured to hermetically seal capture member 110. For instance, sealing member 130 may form a hermetic seal around capture member 110 at extraction system 118 (e.g., when second portion 106 is in the closed position). According to at least some embodiments, sealing member 130 is a flange seal. However, it should be appreciated that sealing member 130 may be or include any suitable style of seal or seals, such as a knife edge seal, a vacuum seal, an O-ring, or the like.

System 100 may include a heating element 132 (FIG. 8). Heating element 132 may be positioned at or near capture member 110. For instance, heating element 110 may be positioned at back plate 121. Heating element 132 may selectively supply heat to capture member 110 (e.g., to gelatin material 114). Thus, heating element 132 may be operably connected with a power supply. In some instances, heating element 132 is a resistance heating element. However, it should be understood that heating element 132 may be or include any suitable style or number of heating elements, and the disclosure is not limited to the examples provided herein.

Embodiments have been developed as a breadboard that demonstrated successful capture and delivery as well as isotopic characterization and abundance measurements of methane-doped water ice particles. These particles were accelerated into a thermally controlled vacuum (TVac at −40° C.) chamber containing the breadboard at speeds of ˜50 m/s using a sample-loading tube pressurized with helium gas. After sample acquisition, the breadboard was robotically sealed, then heated to sublimate the sample and pressurize the internal volume. The pressure difference between the sealed collector volume and hollow fiber drove delivery to the CAS for analysis. This end-to-end demonstration validated the Plume particle acquisition system and has positioned it as a promising development for Enceladus plume flythrough applications.

In some embodiments, the Plume particle acquisition system is desired to distinguish biological from abiotic sources of plume material. One of the best understood potential isotopic biosignatures on Earth is the ratio of heavy to light carbon and hydrogen in methane. The atoms that constitute the methane (CH4) molecule, carbon and hydrogen, have isotopes present in ratios that can reflect the methane source, distinguishing extant life from abiotic formation mechanisms. In some embodiments, it is not the absolute ratio of these isotopologues to be measured, but the difference, or fractionation, between the carbon and hydrogen isotopes of methane and those of the baseline carbon (CO2) and hydrogen species (H2O), which likely represent the source carbon and hydrogen. This fractionation, coupled with the ratio of methane to ethane abundance in the plume, can be diagnostic of extant life and abiotic sources (primordial, hydrothermal, thermogenic). In some embodiments, this diagnosis is independent of the absolute isotopic ratios (D/H and 13C/12C) in plume CH4, CO2, and H2O, which likely differ between Earth and Enceladus owing to different formation conditions in the solar system.

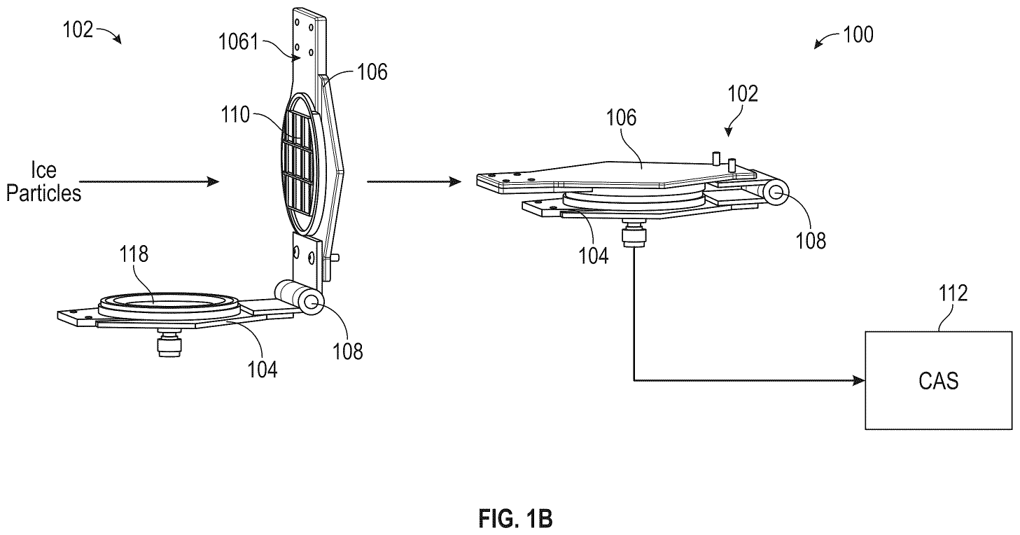

Methane isotopic fractionations on Earth are shown in FIG. 2 relative to isotopic ratios in terrestrial baseline materials: Vienna Pee Dee Belemnite (VPDB) carbonate for carbon, and Standard Mean Ocean Water H2O for hydrogen. In FIG. 2, biological methane produced via catalysis of the reaction between carbon dioxide and hydrogen as CO2+4 H2=2 H2O+CH4 is isotopically lighter in carbon than methane produced by fermentation of organic matter. Methane produced through thermogenesis, hot and cold water-rock reactions is richer in 13C and can also differ in relative deuterium (HD) abundance. The Plume particle acquisition system measurement may place Enceladus at a location on this graph that would provide unique insight into its methane formation mechanism.

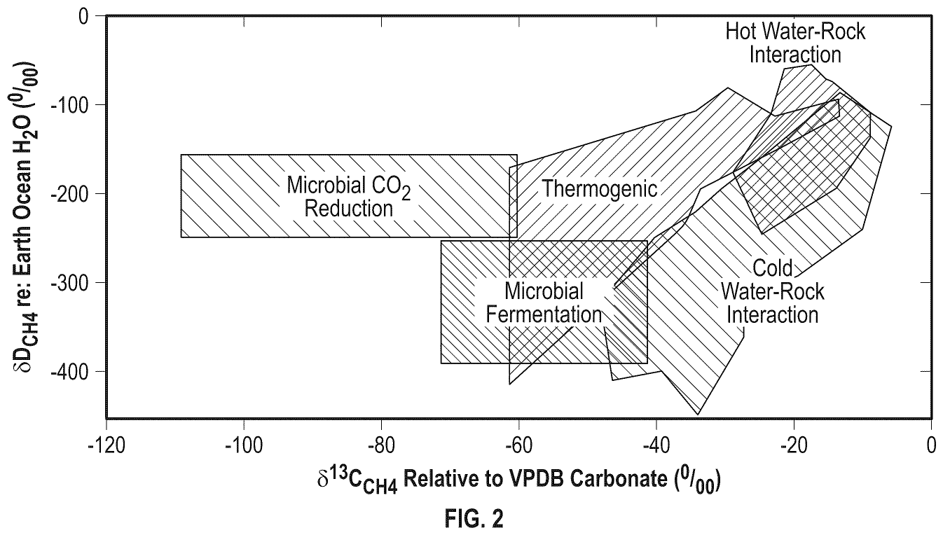

Because biological and abiotic fields of FIG. 2 overlap, it is possible that a measurement could indicate both sources are possible. To increase confidence in measurement interpretations, Plume particle acquisition system also measures the methane-to-ethane ratio (CH4/C2H6) in the plume. As shown in FIG. 3, the ratio of methane to larger hydrocarbons independently allows further distinction between biological and abiotic sources, because the latter tend to generate more ethane and larger hydrocarbons relative to methane.

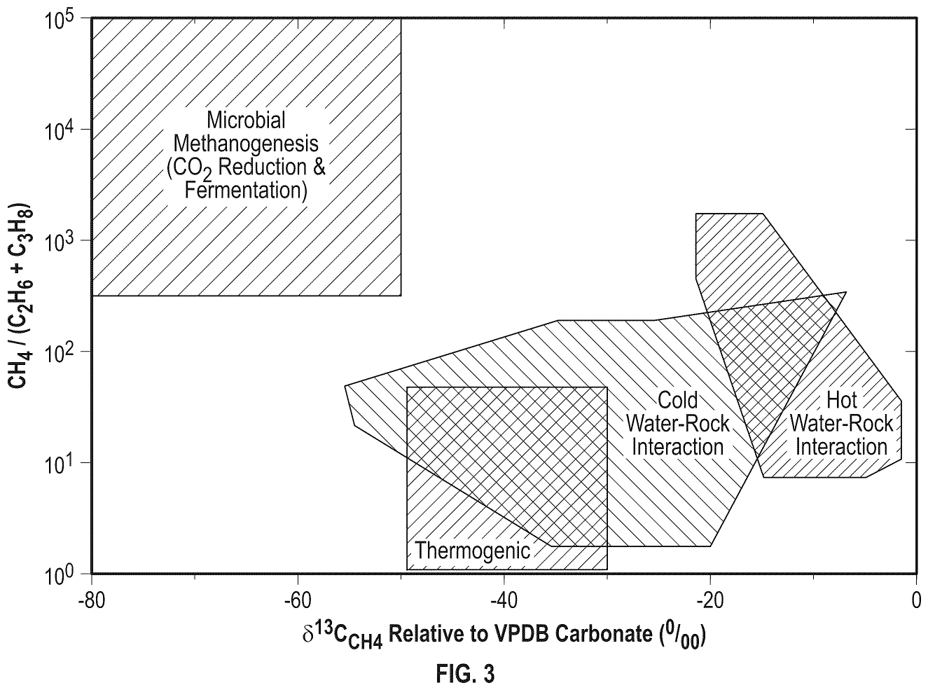

The wavelength ranges probed by the CAS to address the above questions also enable a measurement of 18O/16O and 17O/16O in H2O and CO2. Together with precise D/H ratios in H2O and CH4, and 13C/12C ratios in CO2 and CH4, these measurements place Enceladus on solar system isotopic maps (FIGS. 4A and 4B). The scale of these maps is much broader than that of fractionations due to processes within a planetary body (e.g., FIG. 2). Instead, FIGS. 4A and 4B reveal different formation conditions for the planetary bodies shown. O isotopes plot along a mixing line between 16O-rich and 17,18O-rich material (FIG. 4A), where the 16O-rich endmember is the Sun, i.e., remnant protoplanetary gas. The 17,18O-rich endmember has yet to be found, although rare 17,18O-rich astromaterial has been identified.

Plume particle acquisition system measurements of narrow gas spectral features may allow accurate quantification of these isotopes' ratios, allowing major progress in testing hypotheses such as self-shielding in the formation of the building blocks of outer solar system materials, including those that formed Enceladus. Thus, Plume particle acquisition system may return valuable science irrespective of whether Enceladus is inhabited or of whether the similarity of physical, chemical, and potential biological processes allows inferences about these processes based on how they fractionate isotopes on Earth.

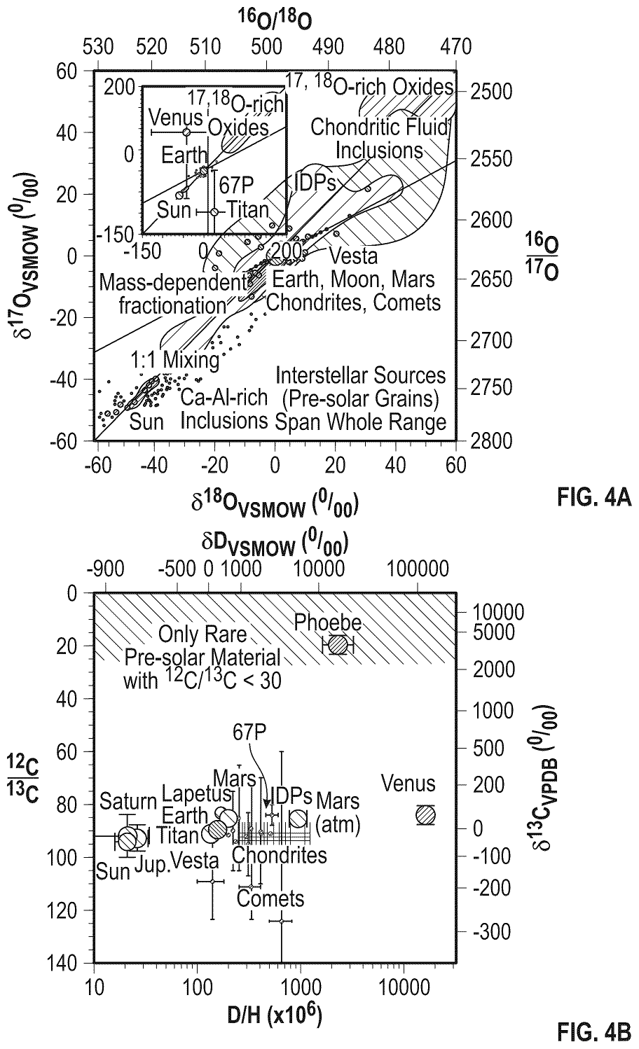

The CAS system may be or include a trace-gas and isotope analyzer that utilizes a low-volume (˜1-10 mL) and compact gas cell. In some embodiments, gas under analysis is drawn into a hollow-core fiber, which is a glass capillary tube with a reflective inner coating that guides a tunable laser beam to a detector. The detector measures absorption spectra as the laser repeatedly sweeps in wavelength over a relatively narrow tuning range. The hollow fiber (length 1 to 5 m) can be coiled leading to a compact system with low SWaP (FIG. 5).

This enables the CAS system to uniquely identify molecular species and isotopologues. This is possible because infrared (IR) laser spectroscopy systems can provide small, unambiguous measurement platforms by exploiting the “molecular fingerprint” region in the mid-infrared (Mid-IR) wavelength range, λ˜2-16 μm. This avoids measurement interferences between molecular species of equal mass. For example, traditional isotope ratio mass spectrometry (IRMS) struggles to accurately measure H217O in water because of mass interference from HDO, while laser spectroscopy can distinctly differentiate between these two isotopologues. Further, traditional IRMS instruments may be ill-suited for remote deployment due to their large size, high power consumption, and stringent vacuum requirements.

The Sample Analysis at Mars (SAM) system aboard Curiosity is an example of an IR tunable laser spectroscopy (TLS) instrument with a multi-pass Herriott cell. However, this gas cell has a sample volume of 400 mL, which can be a challenge to fill in sample-limited applications. The comparison between TLS and the CAS is illustrated in FIG. 5. While the TLS has a 3× longer path length, the CAS is significantly more sensitive in terms of the number of moles required to make a measurement due to the orders of magnitude smaller sample volume along with the fact that there is near unity overlap between the gas inside the hollow fiber and the probing laser beam (i.e., much less dead volume). This feature of the CAS significantly increases sensitivity for exo-atmospheric applications where sample mass is very limited, such as may be anticipated in an Enceladus plume flythrough application.

In an embodiment, the Plume particle acquisition system collector is comprised of an aluminum housing with aerogel tiles on an indium backing (as described above). The combination of aerogel and indium on the sample capture surface enables trapping of both molecules (gas phase) and ice grains (solid phase) from the plume. In an embodiment, aerogel and indium were selected based on flight mission heritage, and laboratory research into sample retention during high relative velocity impacts, and validated in this configuration via lab demonstration of ice grain capture at low relative velocity impacts as discussed herein.

Most ice grains in Enceladus plumes are 10 nm to 10 μm in diameter and therefore should be brought to rest by the aerogel's low-density S-sized filaments. The ˜6 km/s relative velocity impacts observed on Stardust volatilized even rock grains, but much of that volatilized material diffused into the surrounding aerogel and thus was retained. Ice grains that don't vaporize upon impact and make it through the aerogel layer will be entrained in the indium backing. Laboratory research indicates that indium may be an effective capture surface for organic-bearing icy particles traveling <1.5 km/s. Therefore, this combination of materials maximizes capture for ice grains at a range of relative impact velocities.

For capture of gaseous phases, it may be expected for molecules that impact the aerogel at high velocity to remain mostly trapped within the aerogel's structure so long as they are in a vacuum or near-vacuum environment. Once that volume is pressurized to ˜10 kPa or greater, molecules should enter viscous flow, which may be relied upon to enable delivery to the CAS. Indeed, due to constrained volumes within the aerogel, the mean free path of the molecules in aerogel does not exceed 50 nm even at ultra-high vacuum. Therefore, diffusion of mass and energy through the aerogel is much less efficient than in free space. Thus, aerogel may be an effective insulator, as even slight vacuums can provide insulation similar to stronger vacuums. However, once the volume is pressurized, both diffusion and viscous flow can occur due to the wide distribution of pore sizes in aerogels.

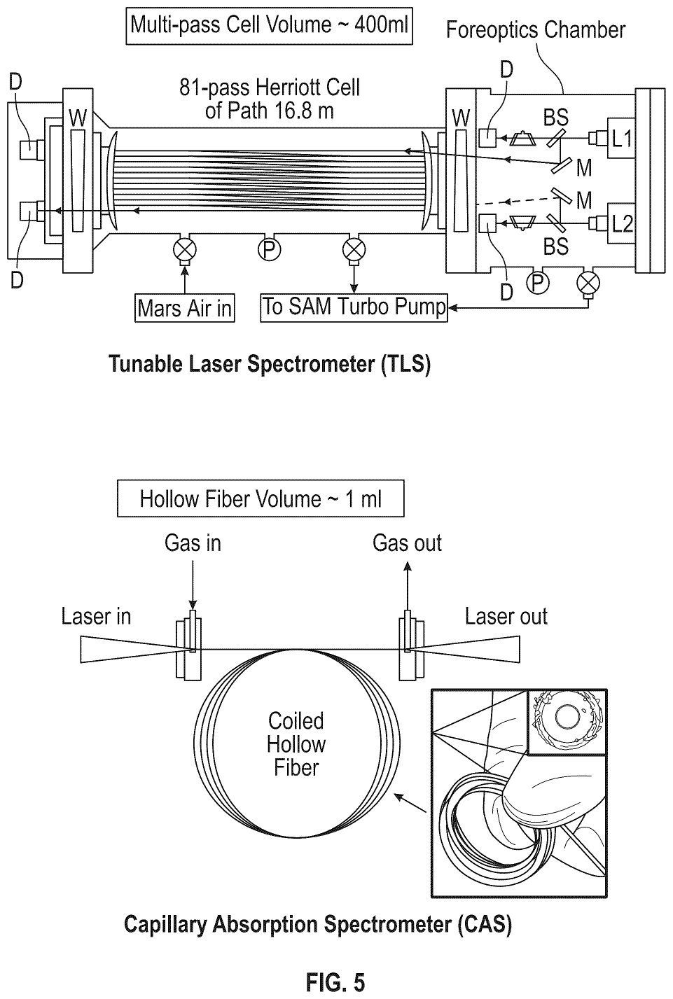

Once sealed, heaters on the back of the collector (behind the aerogel and indium) may heat the housing to sublimate ice grains and loft volatile species. This may pressurize the sealed collector volume and allow for viscous flow of gases through the aerogel. Connected to the collector volume may be a short section of tube (˜3 cm3 volume) with microvalves on either side that acts as a metering volume. When the collector volume is heated, the first valve may be kept open such that gaseous sample also fills this space. This may allow the gas to equilibrate and avoids unwanted fractionation. When ready to make a measurement, this first valve is closed, and a second valve is opened to deliver the aliquot of sample to the CAS for analysis. A block diagram illustrating this concept is shown in FIG. 6.

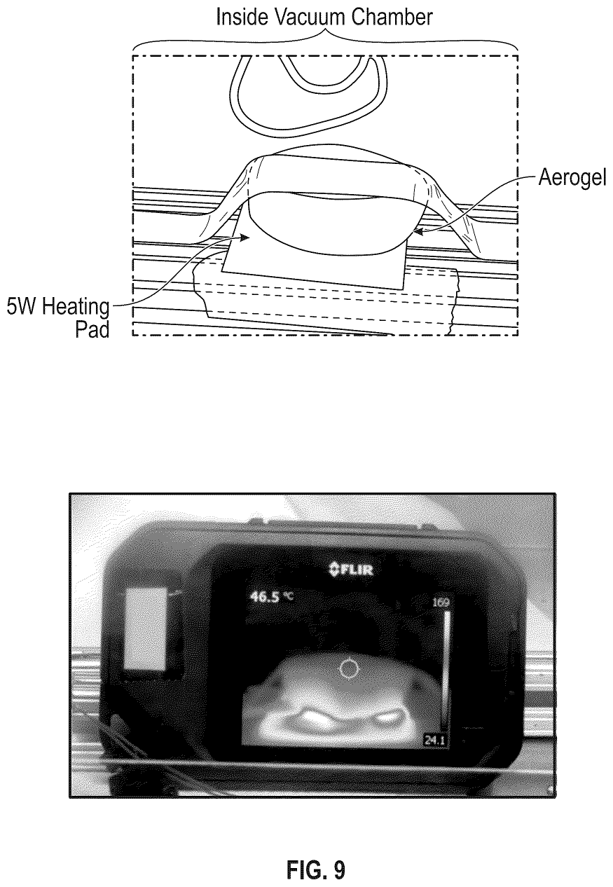

This embodiment delivers a single aliquot at a time of the total gaseous sample. Delivering sample in discrete slugs in this way may enable repeated measurements and, in laboratory testing, has been found to increase measurement precision. Also illustrated in FIG. 9 is a calibrant tank, connected to the metering volume via Valve 1. This may enable the delivery of a known gaseous sample to the CAS for calibration using the same method as plume sample delivery. This embodiment may intentionally increase or maximize the overlap in sample path between plume sample (from the collector) and calibration standard (from the calibrant tank) to make a useful comparison of returned data. Because CAS can measure multiple species at once, multiple calibrants (i.e., H2O, CO2, and CH4 of known concentration and isotopic composition) can be combined in a single tank. In other embodiments, two or more calibrant tanks may be provided, depending on mission measurement requirements. Accordingly, polar lunar volatiles may be analyzed to determine abundance and origin.

To test some of the key technology premises of Plume particle acquisition system, a breadboard system may be used. This may begin with combining separate aerogel monoliths into a single 3×3 capture surface using 3D printed PLA, for example. Later capture surfaces may consist of a printed a PLA grid where aerogel is inserted manually. The capture surfaces being tested may be mounted into an aluminum clamshell housing with a gasket to enable sealing. This clamshell may be mounted on an 80×20 structure and actuated by two linear actuators (shown in FIG. 7 and FIG. 8).

In an embodiment, the Plume particle acquisition system clamshell sealing mechanism compresses an O-ring seal to 20% using linear actuators. Accordingly, a KF seal (leak rate ˜10-2 atm*cc/s) may be sufficient to address the scope of testing. Once sealed, 200 W silicone patch heaters lining the clamshell exterior may warm an interior for sublimating captured ice.

Plume particle acquisition system testing focused on demonstrating or advancing the following crucial elements of the flight concept: (1) aerogel heating and therefore sublimation of entrained ice grains, (2) extraction of methanated ice from aerogel, and (3) transfer of sample to the CAS via a pressure gradient. Other aspects of the Plume particle acquisition system design represent engineering developments rather than core technology demonstration and can draw heritage from previous designs.

In the Plume particle acquisition system embodiment, the heater may be located behind the capture surface to heat the indium and aerogel layers and volatilize entrained ice grains. However, aerogel is an excellent insulator, which raised the question of whether ice grains within the aerogel portion would be sufficiently heated to sublimate. To address this question prior to a full end-to-end development and demonstration, a small-scale experiment was devised. Amorphous silica dioxide was procured with a density of ˜0.095 g/cm3 or roughly 96% vt % air. The ˜2.6 cm2×0.7 cm aerogel monoliths were placed in a vacuum chamber with a one-inch square 5-watt (W) silicone patch heater. The chamber pressure was lowered to 0.04 kPa before powering the heater for 10 minutes. To characterize the change in aerogel temperature, a FLUR C2 thermal camera focused on the top surface of the aerogel.

As seen in FIG. 9, the bottom surface near the heater peaked around 169±2° C. compared to the top surface temperature of 46±2° C. While inefficient, this testing demonstrated that ice embedded in the aerogel could be heated sufficiently with patch heaters in vacuum to sublimate ice.

To establish that methane could be released to the CAS for analysis from the aerogel capture surface, an icy simulant that contained methane was developed. This was accomplished by doping water with methane gas and using an aerosolizer spraying directly into a liquid nitrogen bath, flash freezing this water into spherical particles.

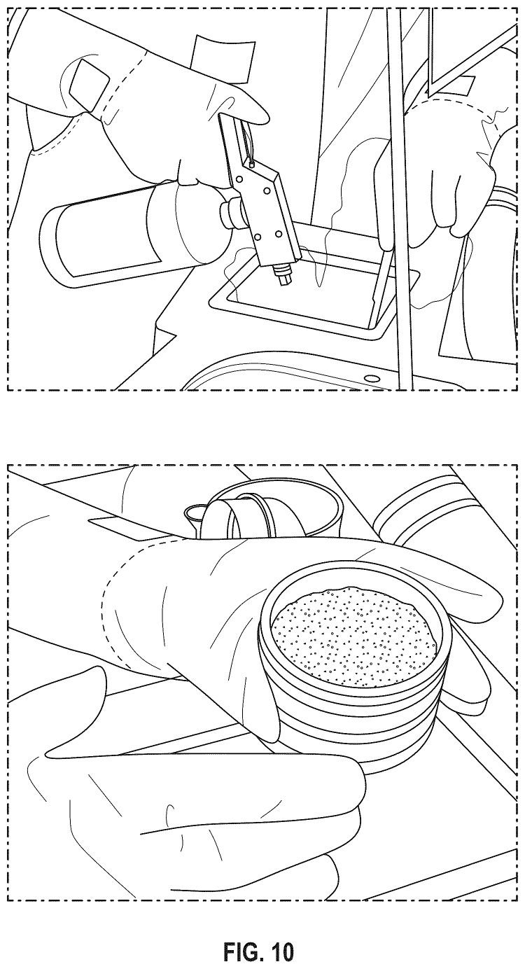

A sprayer was used as the aerosolizer. Methane was dissolved into 500 mL of water by filling the headspace of the aerosolizer with methane gas at 80 psig. After shaking and refrigerating overnight, the sprayer aerosolized the methane infused water into a bath of LN2. The aerosolized water instantly froze upon contact with the LN2, and these particles were scooped out and sieved to be between 100-1000 μm. Images from this process are shown in FIG. 10.

The follow procedure was followed to characterize the quantity of methane trapped in ice particles using this production method:
1. 30 mg of methane ice sample is weighed on a microgram scale.
2. Ice sample is loaded into LN2-cooled KF vacuum container connected to CAS inlet.
3. Container is sealed.
4. Container is heated to 40° C.
5. Container is opened to CAS and CH4 fraction is measured.

Using this approach, the theoretical amount of methane entrained in the ice according to Henry's law would be 2.32*10-7 mol CH4. The measured amount of methane using the CAS was 2.38*10-7 mol CH4. This comparison revealed that nearly 100% of the methane theoretically dissolved in the water is present at the time of analysis of the ice grains, indicating minimal losses to the atmosphere or dissolution in LN2.

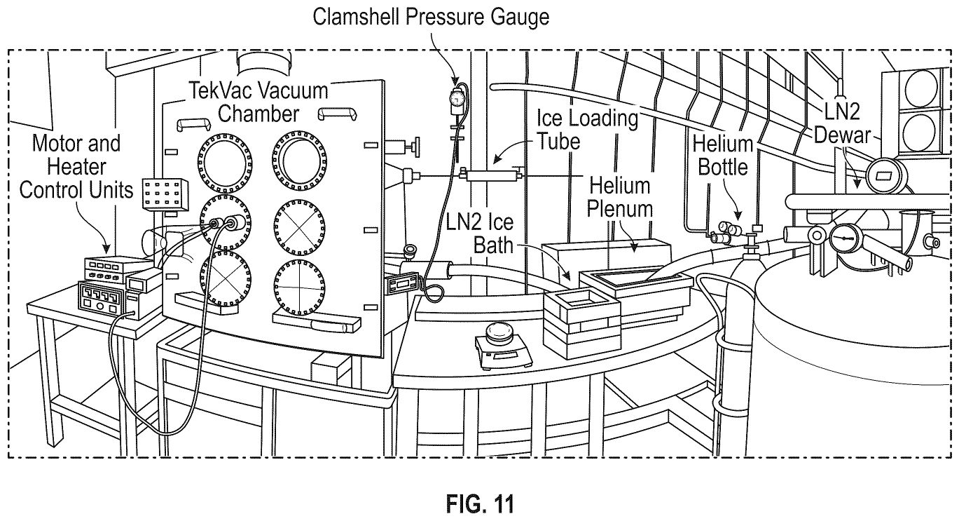

The remaining technology demonstrations used an end-to-end test with the breadboard and newly developed methane ice simulant. Questions to be addressed were (1) whether methane, once trapped in aerogel, could release for delivery to a gas analyzer, and (2) whether the pressure gradient created by sublimated ice grains would be sufficient to drive sample delivery. The testbed used to achieve these goals (FIG. 11) shot methanated ice grains toward Plume particle acquisition system by placing the ice into a Swagelok tube and accelerating it into the vacuum chamber using cryogenic cooled helium. The following procedure was used:
1. Ice is placed into an LN2 cooled Swagelok tubing and sealed off.
2. The ice filled tube is pressurized with helium to 50 psi.
3 The helium is quickly exposed to the evacuated vacuum chamber using a ball valve.
4. Since ice is placed at the inlet to the vacuum chamber, it accelerates with the helium as it enters the chamber.

Of note, the pressurized helium was contained within the plenum pictured FIG. 11. Because the plenum lay in an LN2 bath, it cooled the helium so as not to melt ice before it was released to vacuum. Estimating the total moles of helium entering the chamber was imprecise as the exact temperature of the helium was difficult to quantify. Assuming ˜100° K for helium temperature as it lay in the 80° K LN2 bath with the ˜200 cc of volume (150 cc plenum and 50 cc of tubing), roughly 0.082 mol of He entered the chamber.

While helium entering the chamber is traveling at Mach 1, the ice grains travelled significantly slower. Ice grain speed was measured with a high-speed camera. For He pressures of 50 psi, twelve ice grain tests were performed, and the average speed was 46.6±1.3 m/s.

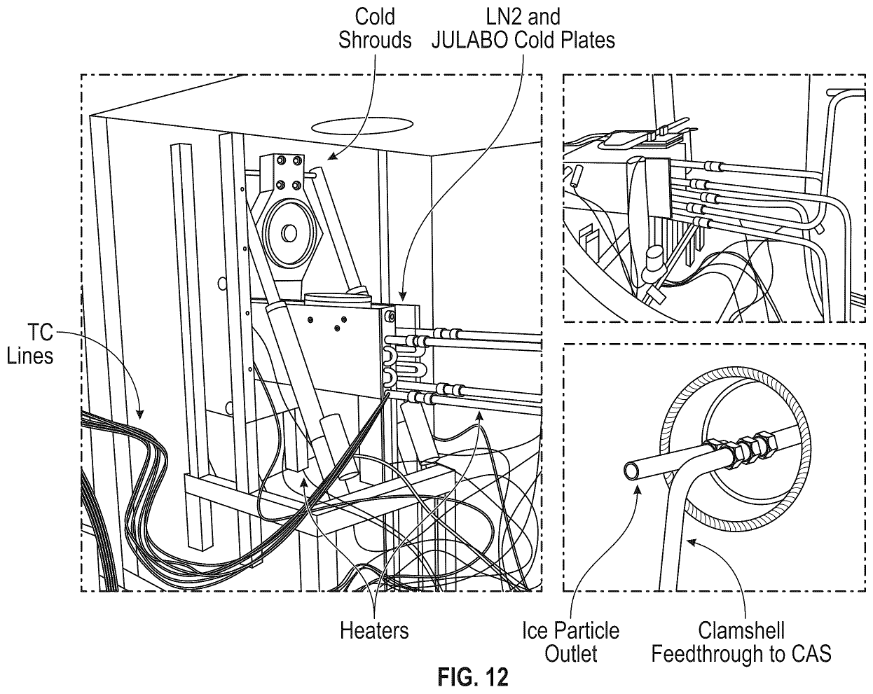

With the Plume particle acquisition system breadboard built, it was installed into a vacuum chamber for testing. A view from inside the chamber is shown in FIG. 12. The clamshell with an aerogel capture surface, actuators, heaters and two LN2 cold plates for cooling were all inside the chamber. A transfer tube fed from the clamshell inside to the CAS system outside the chamber. This tube carried sublimated gaseous sample captured by the aerogel to the CAS via a pressure gradient. All sections of the transfer tube were heated to 35° C. A thermocouple was placed such that it would touch the surface of the aerogel whenever the clamshell lay in a closed position. This enabled measurements of the aerogel surface, and thus presumably the sample itself, throughout the heating process. Pressure inside this transfer tube was measured with a gas independent gauge outside the vacuum chamber.

The procedure for Plume particle acquisition system testing was as follows:
1. With clamshell open, close vacuum chamber and pump down to 0.013 KPa.
2. Heat clamshell to 45° C., this evaporates any residual water in the clamshell. (2 hours)
3. Close clamshell for faster cooling. Vacuum level matches the clamshell and the chamber. (30 sec)
4. Cool the clamshell to between −20° C. and −30° C. (4 hours)
5. Open clamshell
6. Shoot ice particles at the capture surface. (˜1 min)
7. Close clamshell. (1 min)
8. Reheat clamshell to 45° C. (2 hours)
9. Slug measurements into CAS from the clamshell. (30 min)

Once ice grains were captured, the clamshell was sealed and heated to 45° C. During the heating, the pressure inside the clamshell would increase as shown in Table 1.

TABLE 1

| | | | Ice | Post-heating | |
|---|---|---|---|---|---|
| | Capture | Mass of | particle | clamshell | CAS methane |
| Test | surface | ice (mg) | size (mm) | pressure (kPa) | reading (ppm) |
| 1 | Single | 0 | N/A | 0.9 | N/A |
| | aerogel | | | | |
| 2 | 3 × 3 | 1020 | 0.1-1.0 | 0.93 | 125 |
| 3 | 3 × 3 | 800 | 0.1-1.0 | 1.53 | 121 |
| 4 | 3 × 3 | 613 | 0.1-0.2 | 1.44 | 22 |

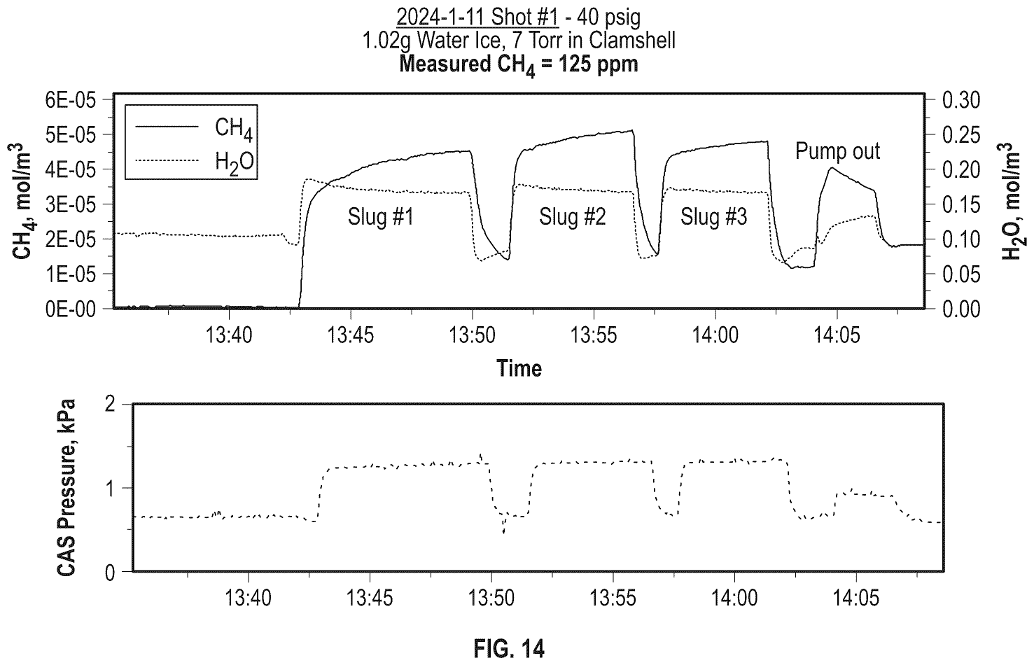

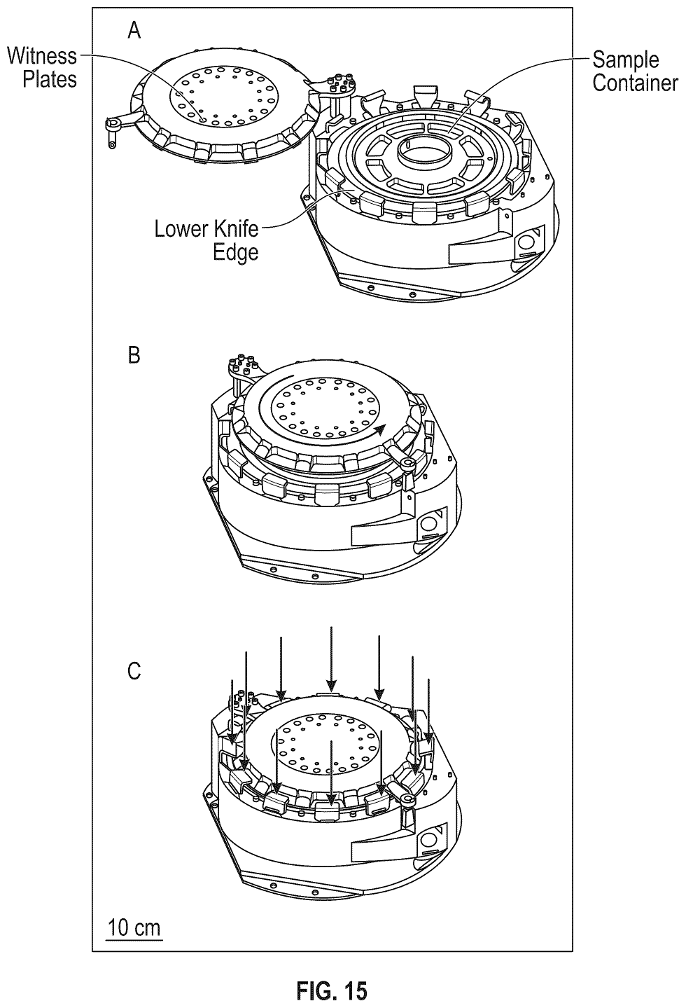

Once the pressure reached a plateau, the clamshell would be opened directly to the CAS volume. As the CAS volume, (10 cc) was relatively small compared to the clamshell (105 cc) the pressure decrease was minimal. To achieve the most accurate measurement, multiple aliquots of captured sample would be metered into the CAS. This “slug” delivery method decreases memory, which is the alteration of the measurement from previous sample or ambient water that has internally coated the surface area of the CAS or other associated tubing. With each additional slug, these internal surfaces become coated instead with the sample of interest and the measurement fidelity increases. A graph of CAS measurements illustrating this effect are shown in FIG. 14.

Four trials of this end-to-end testing was completed. An initial control test (in which no ice was loaded in the loading tube) followed both ice shooting and Plume particle acquisition system testing procedures. Instead, an empty loading tube with 50 psi He gas at the estimated 80° K was shot at the aerogel. The capture surface for these tests was a single aerogel monolith attached to the PLA backing. Indium covered the remaining PLA surface. It is not believed that the difference in aerogel configuration altered the results of the control as there was no ice to entrap in the aerogel. After releasing helium, the clamshell was closed, and the pressure rose with increasing temperature.

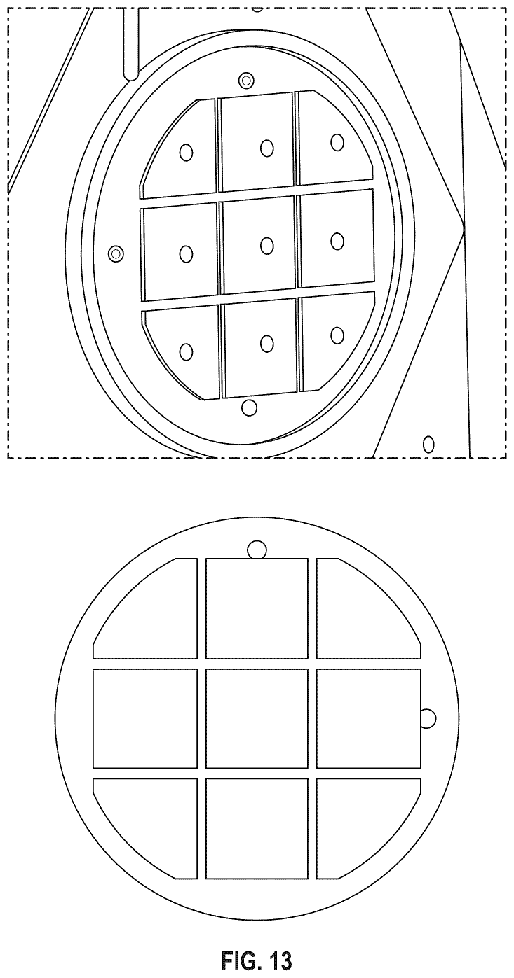

For the following tests, three aerogel grids were made. As can be noted in the aerogel in FIG. 13, the impact from both the ice and helium degraded the aerogel surface. To ensure equal capture potential, the aerogel grids were replaced for each test. The aerogel grids in FIG. 13 are from Test #4: during and after ice particle impact. Due to the relatively high aerogel temperature between −20° C. and −30° C. as well as the low vacuum level in the chamber, much of this ice sublimated within seconds. Ice that remained after closing the clamshell contributed to the positive pressure rise. Lower capture surface temperatures would vastly improve the capture efficiency for both gaseous and icy phases of plume material. Especially at these low impact speeds, ices deposits on the surface of the aerogel rather than penetrating the monolith and therefore is quick to sublimate from a relatively warm surface.

Test results consistently showed pressure rise in the clamshell and high concentrations of methane delivered to the CAS. The variability in both levels of pressure rise and methane concentration are attributed to limitations of the TRL 4 testbed. Specifically, the clamshell temperature during capture was between −20° C. and −30° C. as opposed to a more flight-like temperature profile where the clamshell would be at ˜100K or lower. As a result, the sublimation rate of ice immediately after impact was significantly higher than we might expect in a flight environment.

Further, the method of accelerating ice toward the clamshell posed a challenge in testing. The relatively low velocity particles (˜45 m/s) penetrated 0.2-0.4 mm into the aerogel surface. As a result, the relatively large volume of helium gas blew away an inconsistent quantity of the ice grains after each impact with the aerogel, contributing to the inconsistency in pressure rise as well as methane concentration.

The process of bringing the Plume particle acquisition system to a NASA Technology Readiness Level (TRL) 4 involves three technology demonstrations. These included (1) aerogel heating and therefore sublimation of entrained ice grains, (2) extraction of methanated ice from aerogel, and (3) transfer of sample to the CAS system via a pressure gradient. As observed in initial testing, heating aerogel with a patch resistive heater will create a temperature gradient such that ice grains can be sublimated in vacuum. That conclusion was further confirmed when measuring the aerogel with TC in end-to-end testing showed the aerogel would rise to 45° C. after a few hours. CAS measurements of methane also indicated that methane was being extracted, but it remains to be seen if this would be the case for higher relative velocity impacts in which ice grains would be more deeply entrained in aerogel.

Finally, sample delivery to the CAS system relying on a pressure gradient also held promising results. Despite difficulties in capture efficiency due to limitation of the TRL 4 level testbed, numerous strong measurements of methane showed sample was be captured and then delivered to the CAS system via this pressure gradient. This result indicates that Plume particle acquisition system could be a powerful instrument as in-line gas deliver instrument for multiple space exploration missions.

The testing described herein validated the Plume particle acquisition system to a TRL 4 fidelity. It is anticipated that this technology may be extended to TRL 6, such that it may proposed to future flight opportunities. This entails pursuing three avenues, described here.

First is testing the hypothesis described herein that aerogel will trap gaseous phases of the Enceladus plume (which may also contain large amounts of methane). Molecular species will be moving at speeds >1 km/s due to the adiabatic expansion the plume gas undergoes as it erupts from the subsurface of Enceladus into the vacuum of space. Therefore, to demonstrate gas capture, a similar test as the one described here may be performed using calibrant gases (of known isotopic composition and trace gas concentration) accelerated into vacuum. This acceleration could be accomplished by taking advantage of similar engineering principles that underlie a rocket engine: sending the gas through a converging and diverging nozzle to accelerate it into vacuum and at the sample capture surface.

Another key development is testing the aerogel for high velocity impacts of ice grains. The TRL 4 testing validated the system at speeds representative of an Enceladus orbiter, but flyby missions (orbiting Saturn) would impact at much higher speeds and thus require a dedicated test campaign. This would require specialized facilities, such as a light gas gun. Results from the Stardust mission indicate this capture into aerogel be successful, but assessing any impact to CAS measurements would be a crucial aspect of this testing.

Lastly, flight-forward packaging must also be considered. Towards this end, a design concept (FIG. 1) has been developed based on the Comet Astrobiology Exploration SAmple Return (CAESAR) mission, one of two selected for Phase A study by NASA's New Frontiers program. In an embodiment of another sample containment system is shown in FIG. 12. In this embodiment, the lid swings or rotates in-plane and creates a hermetic knife-edge seal. Where CAESAR held the sample container for return to Earth, the Plume particle acquisition system would house the sample handling and CAS instrument systems. The lid of the sealing system for sample return is used as the sample collector.

Embodiments provided herein provide for a Plume particle acquisition system that includes an all-in-one sample capture, sample handling, and trace gas and isotope analysis system for use in detecting potential biosignatures at Enceladus during a plume flythrough mission. End-to-end demonstration testing of methane-doped ice particles was shot at a breadboard sample collector in cold (−30C) vacuum conditions to verify TRL 4.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It should also be noted that the terms “first”, “second”, “third”, “upper”, “lower”, and the like may be used herein to modify various elements. These modifiers do not imply a spatial, sequential, or hierarchical order to the modified elements unless specifically stated.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A system for capturing ice particles in a vacuum, the system comprising:
a capture assembly, the capture assembly comprising:
a stand;
a base portion supported by the stand;
a catch portion rotationally coupled to the base member, the catch portion being rotatable between a closed position and an open position with respect to the base portion;
a flange sealing member positioned between the base portion and the catch portion, the flange sealing member hermetically sealing the capture member with the extraction system when the catch portion is in the closed position;
a capture member coupled to the catch portion, the capture member having a support member coupled to a aerogel material, the aerogel material having a density configured to trap particles therein, the support member having a plurality of cross-tines arranged to form a grid pattern, the capture member further having a back plate in planar contact with the catch portion, the back plate being made from a soft metal sheet;
an extraction system positioned at the base portion, the extraction system selectively coupling with the capture member when the catch portion is in the closed position, the extraction system having a capillary absorption spectrometer (CAS), the extraction system being configured to transfer material from the trapped particles to the CAS when the catch portion is in the closed position;
an actuator assembly coupling the catch portion with the base portion, the actuator assembly having a first actuator arm and a second actuator arm, the first actuator arm coupled to each of the stand and the catch portion at a first lateral side and the second actuator arm coupled to each of the stand and the catch portion at a second lateral side, the actuator assembly further having a power supply operably coupled to each of the first actuator arm and the second actuator arm; and
a heating element positioned at the capture member.

2. A system for capturing ice particles in a vacuum, the system comprising:
a capture assembly, the capture assembly comprising:
a base portion;
a catch portion coupled to the base member, the catch portion being movable between a closed position and an open position with respect to the base portion;
a capture member coupled to the catch portion, the capture member configured to trap particles therein;
an extraction system positioned at the base portion, the extraction system selectively coupling with the capture member when the catch portion is in the closed position; and
an actuator assembly coupling the catch portion with the base portion.

3. The system of claim 2, wherein the catch portion is coupled to the base member via a hinge member.

4. The system of claim 2, wherein the capture member comprises:
a gelatin material having a predetermined density.

5. The system of claim 4, wherein the gelatin material comprises an ultralight aerogel.

6. The system of claim 4, wherein the capture member further comprises:
an insert member configured to support the gelatin materials.

7. The system of claim 6, wherein the insert member comprises a grid pattern formed by a plurality of cross-tines.

8. The system of claim 2, further comprising:
a stand, wherein the base member is supported at the stand.

9. The system of claim 8, wherein the actuator assembly comprises:
a first actuator arm coupled to each of the stand and the catch portion at a first lateral side thereof;
a second actuator arm coupled to each of the stand and the catch portion at a second lateral side thereof; and
a power supply operably coupled to each of the first actuator arm and the second actuator arm.

10. The system of claim 9, wherein each of the first actuator arm and the second actuator arm is a linear actuator.

11. The system of claim 2, further comprising:
a sealing member positioned between the base portion and the catch portion, the sealing member configured to hermetically seal the capture member with the extraction system when the catch portion is in the closed position.

12. The system of claim 11, wherein the sealing member comprises a flange seal.

13. The system of claim 2, wherein the capture member further comprises:
a back plate in planar contact with the catch portion, the back plate comprising a soft metal sheet.

14. The system of claim 2, wherein the extraction system further comprises:
a capillary absorption spectrometer (CAS), wherein material from the trapped particles is delivered to the CAS when the catch portion is in the closed position.

15. The system of claim 2, further comprising:
a heating element positioned at the capture member.
